(19) United States
(12) Patent Application Publication
(10) Pub. No.: US 2024/0142265 A1
(43) Pub. Date: May 2, 2024

(54) METHOD FOR CREATING AND PROVIDING AN ENHANCED ENVIRONMENT MAP

(71) Applicant: Continental Autonomous Mobility Germany GmbH, Ingolstadt (DE)

(72) Inventors: Ralph Grewe, Modautal (DE); Stefan Luthardt, Darmstadt (DE); Alice Natoli, Bodolz (DE); Julien Seitz, Darmstadt (DE)

(73) Assignee: Continental Autonomous Mobility Germany GmbH, Ingolstadt (DE)

(21) Appl. No.: 18/495,401

(22) Filed: Oct. 26, 2023

(30) Foreign Application Priority Data
Oct. 28, 2022 (DE) 10 2022 211 487.6

(51) Int. Cl. G01C 21/00; G06F 18/25; G06N 3/02

(52) U.S. Cl. CPC G01C 21/3848; G01C 21/3878; G06F 18/256; G06N 3/02

(57) ABSTRACT

A method for providing an enhanced environment map for use in vehicles, including: receiving sensor data from sensors of at least one vehicle; evaluating the sensor data; setting location-dependent sensor data by associating the sensor data with a position in an environment map; identifying detection accuracies of the sensors based on the location-dependent sensor data; entering the detection accuracies as sensor models into the environment map in the corresponding positions of the location-dependent sensor data in order to create an enhanced environment map; and providing the enhanced environment map to at least one vehicle.

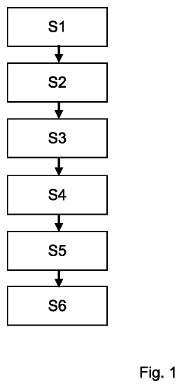

### CROSS-REFERENCE TO RELATED APPLICATIONS

The present application claims priority from German Patent Application No. 10 2022 211 487.6 filed on Oct. 28, 2022, the content of which is herein incorporated by reference.

### BACKGROUND

### 1. Field

Aspects and objects of embodiments of the present application relate to a method for creating and providing an enhanced environment map.

### 2. Description of Related Art

It is known from the state of the art that so-called sensor models are needed for sensor data processing, e.g. for localization, but also for data fusion and tracking. For the purpose of data processing, these sensor models model relevant features of the sensors, such as the accuracy of a measurement in the radial or azimuthal direction or the detection probability, i.e. the probability with which an obtained measurement represents a real target/object or with which a real target/object is overlooked or not detected by the sensor.

### SUMMARY

According to an aspect of an embodiment, there is provided a method by means of which an enhanced environment map can be created and provided, thereby improving the accuracy and robustness of sensor detections.

Initial considerations involved the fact that, as a rule, sensor models today are, in practice, fixedly set up once by, for example, identifying an optimal set of parameters via a specific number of measurements. In simple models, the same model is used for each measurement cycle. However, there are also approaches which adapt a model according to a specific scenario, as, for example, the probability of a false-positive detection is higher in a tunnel than on an “open” road. A location-dependent adaptation of sensor models is not known.

Especially for localization and the static surroundings or open space, a plurality of measurement points from the vehicle environment are used. Elaborating on the example of the tunnel, the parameters of the sensor model are heavily dependent on the environment.

As the described features can, as a rule, be associated with a fixed position in the world, embodiments of the present application relate to a location-dependent sensor model and place it in a map as an additional layer.

In the following, the combination of detection probability and measurement accuracy are consolidated into the term detection accuracy.

According to an aspect of an embodiment, there is provided a method is provided for creating and providing an enhanced environment map for use in vehicles, including: receiving sensor data from sensors of at least one vehicle in a back-end server; evaluating the sensor data in the back-end server; setting location-dependent sensor data by associating the sensor data with a position in an environment map; identifying detection accuracies of the sensors based on the location-dependent sensor data; entering the detection accuracies as sensor models into the environment map in the corresponding positions of the location-dependent sensor data in order to create an enhanced environment map; and providing the enhanced environment map to at least one vehicle.

The sensor data can in this case comprise raw sensor data or a raw-data-like representation. It would also be plausible for data already classified in the vehicle to be transmitted to the back-end server. Preferably, data are transmitted from a plurality of vehicles, e.g. a fleet of vehicles, to the server, where they are then evaluated. This is, in particular, preferable, because individual detection inaccuracies due to sensors can be determined in this way.

During the evaluation of the sensor data, objects in the vehicle surroundings can, for example, be identified from the sensor data. During the setting of the location-dependent sensor data, the evaluated sensor data are associated with positions in the environment map. The positions of the sensor data can, for example, be located on the map by means of an association of a GPS location. Alternative or cumulative entering of the sensor data, e.g. in an occupancy grid, would also be plausible. In this case, the relative position to the recording vehicle could also be documented. When identifying detection accuracies of the sensors based on the location-dependent sensor data, it can be determined through the location-dependent sensor, based on the knowledge about the environment, how probable a certain detection is or what level of accuracy is to be expected in the determined surroundings. For example, vegetation, as a rule, leads to lower detection accuracy. Building walls can be measured with very high detection accuracy, whereas parked vehicles, for example, deliver very good measurement points, but these points, depending on the parking situation, appear in different positions and thus lead to only medium detection accuracy for, for example, localization. It is further particularly advantageous to learn the sensor models in the back-end, as, due to systematic errors, the necessary detection accuracy can only be insufficiently determined with a single journey. For example, after a single journey, a parked vehicle looks like a very specific target. Only during many trips with different parked vehicles in slightly different positions can systematic errors be recognized and good models be determined for the detection accuracy.

Entering in the detection accuracies as sensor models is advantageous in that this allows sensor models to be entered for different types of sensors and provided for the corresponding sensors.

The thus created enhanced environment is then provided to vehicles via download. There, the factors of the algorithms for localization, tracking, and fusion can be read out and be used in the internal signal processing in order to contribute to higher quality in terms of accuracy and robustness of the obtained position or to contribute to the object quality.

In a preferred configuration, the sensor models are entered into the environment map as an additional map layer. This way, for example, the sensor models can be entered in an occupancy grid per cell in an additional layer. The corresponding layer would, in principle, be evaluated by the fusion algorithms in place of, e.g., statically stored values during the processing of a new sensor measurement.

Particularly preferably, the sensor models contain a factor for the accuracy in the radial, azimuthal, and height directions as well as probabilities for false-positive detections and false-negative detections. This is advantageous, as these factors and probabilities can be directly considered during the sensor recordings at the corresponding positions, which contributes to an increased detection accuracy.

Furthermore, in a preferred embodiment, setting the location-dependent sensor data is performed based on localization and/or tracking and/or fusion of the sensor data. This can be performed in the vehicle or in the back-end server. With a performance in the vehicle, the already processed data would be transferred to the server. With a performance in the back-end server, the respective vehicle would transfer raw data or raw-data-like representations to the server.

In a further preferred configuration, it is provided that fusion filters, static or dynamic environment occupancy maps or Kalman filters are used for the localization and/or tracking and/or fusion. During the localization, tracking or fusion, data, e.g. regarding possible association or the accuracy of the position measurement by comparing the prediction of the internal filter state and the current measurement, arises in the fusion filters, e.g. particle filters, static or dynamic occupancy grids or Kalman filters. From this data, a measurement for the detection accuracy can be determined depending on the environment. This data can be provided directly by the vehicle or, as previously described, be generated by performing the respective method in the back-end server, wherein the advantage of the back-end is that the data processing looks the same independently of the concrete vehicle type, there are fewer limitations regarding computing time, and access to all internal states is possible in a simple manner.

Particularly preferably, setting the location-dependent sensor data is carried out by means of classifying the sensor data using a neural network. The classification by means of a neural network preferably takes place on the back-end server, as there are fewer or no limitations regarding computing performance and computing time. Using CNNs, a semantic classification of the environment in street, vegetation, building, parking spaces, etc. occurs in the raw data or on intermediate representations such as the dynamic grid. Based on this classification, the detection accuracy can advantageously be determined. This method can also be combined with the determination from internal data. For example, a convolutional neural network (CNN) or a recurrent neural network (RNN) can be used as the neural network, wherein the networks undergo corresponding prior training with correspondingly classified data.

### BRIEF DESCRIPTION OF THE DRAWINGS

Further advantageous configurations and embodiments are the subject matter of the FIGURE, which shows a schematic representation of a method according to an embodiment of the application.

### DETAILED DESCRIPTION

The FIGURE shows a schematic representation of a method according to an embodiment of the application. In the method for creating and providing an enhanced environment map in vehicles, the following steps are performed. In Step S1, sensor data is received from sensors of at least one vehicle in a back-end server. Preferably, sensor data from a plurality of vehicles is transmitted. In a Step S2, the sensor data is evaluated in the back-end server. In Step S3, location-dependent sensor data is set by associating the sensor data with a position in the environment map. In Step S4, detection accuracies of the sensors are identified based on the location-dependent sensor data. In Step S5, the detection accuracies are entered as sensor models into the environment map in the corresponding positions of the location-dependent sensor data in order to create an enhanced environment map. Finally, in Step S6, the enhanced environment map is provided to at least one vehicle.

1. A method for providing an enhanced environment map for use in vehicles, the method comprising:
receiving sensor data from sensors of at least one vehicle;
setting location-dependent sensor data by associating the sensor data with a position in an environment map;
identifying detection accuracies of the sensors based on the location-dependent sensor data;
entering the detection accuracies as sensor models into the environment map in the corresponding positions of the location-dependent sensor data to create an enhanced environment map; and
providing the enhanced environment map to at least one vehicle.

2. The method according to claim 1, wherein entering the detection accuracies as sensor models into the environmental map comprises entering the sensor models into the environment map as an additional map layer.

3. The method according to claim 1, wherein the sensor models contain a factor for the accuracy in radial, azimuthal, and height directions, and probabilities for false-positive detections and false-negative detections.

4. The method according to claim 1, wherein setting the location-dependent sensor data comprises setting the location-dependent sensor data based on localization and/or tracking and/or fusion of the sensor data.

5. The method according to claim 4, wherein setting the location-dependent sensor data comprises fusion filters, static or dynamic environment occupancy maps, or Kalman filters performing the localization and/or tracking and/or fusion.

6. The method according to claim 1, wherein setting the location-dependent sensor data comprises setting the location-dependent sensor data comprises classifying the sensor data using a neural network.
